(19) United States
(12) Patent Application Publication
(10) Pub. No.: US 2010/0082877 A1
(43) Pub. Date: Apr. 1, 2010

(54) MEMORY ACCESS CONTROL APPARATUS

(76) Inventor: Tetsuro Takizawa, Tokyo (JP)

Correspondence Address: Mr. Jackson Chen, 6535 N. STATE HWY 161, IRVING, TX, 75039, US

(21) Appl. No.: 12/595,661

(22) PCT Filed: Apr. 24, 2008
(86) PCT No.: PCT/JP2008/057884

§ 371 Date: Oct. 13, 2009

(30) Foreign Application Priority Data
Apr. 26, 2007 (JP) 2007-117318

(51) Int. Cl. G06F 12/06

(52) U.S. Cl. 711/5; 711/E12.082

(57) ABSTRACT

A memory access control apparatus includes an arbiter and a sub-arbiter receiving and arbitrating access requests from a plurality of memory masters; a memory controller; and a memory having a plurality of banks. When a bank of the memory used by an access request allowed by the arbiter and currently being executed and a bank of the memory to be accessed by an access request by the sub-arbiter are different and the type of access request allowed by the arbiter and currently being executed and the type of memory access to be performed by the sub-arbiter are identical, then it is decided that access efficiency will not decline, memory access by the arbiter is suspended and memory access by the sub-arbiter is allowed to squeeze in (FIG. 1).

This application is the National Phase of PCT/JP2008/057884, filed Apr. 24, 2008, which is based upon and claims the benefit of previous Japanese Patent Application No. 2007-117318, filed on Apr. 26, 2007, which is hereby incorporated by reference herein in its entirety.

### TECHNICAL FIELD

This invention relates to a memory access control apparatus and, more particularly, to an apparatus suited for application to memory access control for reducing memory access latency of a prescribed memory master in a unified memory architecture or multiprocessor system.

### BACKGROUND ART

In a unified memory architecture or multiprocessor system, a plurality of memory masters make time-shared use of a single memory.

FIG. 5 is a diagram illustrating an example of the typical configuration of a memory access control apparatus. With reference to FIG. 5, access requests from a plurality of memory masters in a memory access control apparatus 10′ are arbitrated by an arbiter 20′ and an access request of a memory master that has been allowed is issued to a memory 50 via a memory controller 40′.

As for the timing of arbitration by the arbiter 20′, arbitration is carried out upon completion of an access request of a burst length more than one from a memory master. As a consequence, during the time that a certain memory master is using the memory 50, another memory master cannot use the memory 50 until the current access is completed.

FIG. 6 is a diagram for describing an example of operation of the memory access control apparatus 10′ of FIG. 5. At time T0, a read access request of an eight burst length to a bank 0 of the memory 50 is issued from a memory master A, and at time T1, a memory access request of 8-burst length is output from the arbiter 20′ to the memory controller 40′.

At time T4, although a memory master C outputs a read access request of 4-burst length to a bank 1 of memory 50, the memory controller 40′ is executing the memory access request from the memory master A and the memory access request from the memory master C is not processed. At time T9, memory access from the memory master A ends and the memory access request from the memory master C is executed.

In the example shown in FIG. 6, if there is an access request from the memory master C at timing T4 during the execution of the access request from memory master A from timing T0, the access request from the memory master C is made to wait and processing of the access request (a 4-byte burst read to bank 1) from the memory master C is executed after the processing of the access request (an eight-byte burst read to bank 0) of memory master A ends.

Patent Document 1 discloses a memory control apparatus for optimizing setting of burst length with respect to an access request of any burst length, and reducing updating of burst length as much as possible. The invention of Patent Document 1 reduces the frequency with which a mode register is set.

Patent Document 2 discloses a memory access apparatus having access dividing means for dividing a memory access request, which has been arbitrated by arbitration means, into memory access instructions of a plurality of memories that access data of a fixed length, and issuing the memory access instructions to memory control means. This invention divides a memory access request of the memory access means, which request is input to the arbitration means, by the access dividing means and causes a memory access request from a CPU to squeeze in between divided memory access instructions.

As an arrangement having a plurality of arbitration circuits, reference should be had to the description in Patent Document 3, by way of example.

Patent Document 4 discloses an input/output control apparatus in which, when it is evident that a data transfer request from a high-priority port will wait because a main memory is busy, a data transfer request to a main-memory bank for which the main memory is not busy is selected and sent to the main memory even if the request is from a low-priority port. A state in which the input/output apparatus waits is avoided and it possible to perform a highly efficient data transfer.

[Patent Document 1]

Japanese Patent Kokai Publication No. JP2001-135079A

[Patent Document 2]

Japanese Patent Kokai Publication No. JP2002-123420A

[Patent Document 3]

Japanese Patent Kokai Publication No. JP2005-316609A

[Patent Document 4]

Japanese Patent Kokai Publication No. JP-A-59-225426

### SUMMARY

An analysis of the related art according to the present invention is offered below.

As described with reference to FIGS. 5 and 6, access requests from a plurality of memory masters are arbitrated by the arbiter 20′. With regard to the timing of arbitration, however, arbitration is merely carried, out upon completion of an access request of a burst length greater than or equal to 2 from a memory master. As a consequence, during the time that a certain memory master is using the memory, another memory master cannot use the memory 50 until the current access is completed.

In a unified memory architecture or multiprocessor system, there are cases where memory access cannot start immediately even through a memory master issues an access request to the memory. As a result, it is difficult to shorten memory access latency.

Further, in a unified memory architecture or multiprocessor system, memory accesses from a plurality of memory masters contend and therefore an enhancement of memory band width is sought. In order to achieve this, however, it is required that memory access efficiency be raised.

In order to raise memory access efficiency, enlarging the burst length of per-time memory access of the memory master is effective. However, this leads to further prolongation of memory access latency.

Memory access latency has a major effect upon CPU performance. In a unified memory architecture or multiprocessor system, therefore, a problem is that it is difficult to improve CPU performance.

Accordingly, an object of the present invention is to provide a memory access control apparatus in which it is possible to reduce memory access latency of access from a prescribed memory master.

The invention disclosed in the present application has the structure set forth below in order to solve the problems cited above.

The memory access control apparatus according to a first aspect of the present invention comprises:

a plurality of memory masters, each of which issues an access request to a memory;

an arbiter receiving access requests from the plurality of memory masters and arbitrating the access requests;

a sub-arbiter receiving access requests from at least some memory masters of the plurality of memory masters and arbitrating the access requests thereof; and

a memory controller receiving access requests from the arbiter and sub-arbiter and carrying out memory access to a memory connected thereto,

wherein in a case where the type of an access request allowed by the arbiter and currently being executed and the type of access to be performed by a memory master via the sub-arbiter are identical, the memory controller suspends memory access by the arbiter and allows the memory access by the sub-arbiter to squeeze in. In the first aspect of the present invention, the memory has a single bank configuration.

In a second aspect of the present invention, in a case where a bank of memory used by an access request allowed by the arbiter and currently being executed and a bank of memory to be accessed by a memory master via the sub-arbiter are different and the type of an access request allowed by the arbiter and currently being executed and the type of access to be performed by a memory master via the sub-arbiter are identical, the memory controller suspends memory access by the arbiter and allows the memory access by the sub-arbiter to squeeze in.

In the present invention, the sub-arbiter monitors a memory access request by a prescribed memory master, the memory access latency of which is desired to be shortened and grants priority to an access request from the sub-arbiter over an access request from the arbiter.

In the present invention, the arbiter includes an access dividing section dividing two access requests from the memory master whose access request has been accepted by the arbiter into a plurality of access requests and generating addresses of the access requests after division.

In the second aspect of the present invention, the memory has a plurality of banks.

In the present invention, if a memory access request has been issued from the memory master and memory access is not being executed, the arbiter executes the access request from the memory master, and in a case where access requests have been issued from the plurality of memory masters, the arbiter selects the memory master for which the access request is to be executed from among these memory masters in accordance with a predetermined criteria, and the memory controller executes the access request that the arbiter has selected.

In the present invention, the memory controller generates a memory control signal in accordance with access requests from the arbiter and sub-arbiter and executes memory access, and in a case where memory access requests have been issued from both the arbiter and sub-arbiter, the memory controller executes the memory access request of the sub-arbiter at a higher priority.

In the present invention, in a case where there are two or more of the memory masters which satisfy a condition that there will be no decline in memory access efficiency even if memory access for which the access request has been allowed by the arbiter and which is currently being executed and memory access that the sub-arbiter has accepted are executed in succession when the sub-arbiter has accepted access requests from a plurality of the memory masters while the memory controller that has received an access request from the arbiter issued by the memory master is executing memory access, the sub-arbiter will select the memory master for which the access request is to be executed from among these memory masters in accordance with a predetermined criteria, and the memory controller will execute the access request that the sub-arbiter has selected.

In accordance with the present invention, it is possible to provide a memory access control apparatus in which memory access latency of access from a prescribed memory master can be reduced.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram illustrating the configuration of an exemplary embodiment of the present invention;

FIG. 2 is a diagram illustrating the configuration of an arbiter in an exemplary embodiment of the present invention;

FIG. 3 is a diagram illustrating the configuration of a sub-arbiter in an exemplary embodiment of the present invention;

FIG. 4 is a diagram illustrating an example of a memory access sequence in an exemplary embodiment of the present invention;

FIG. 5 is a diagram illustrating the configuration of a system according to the related art; and

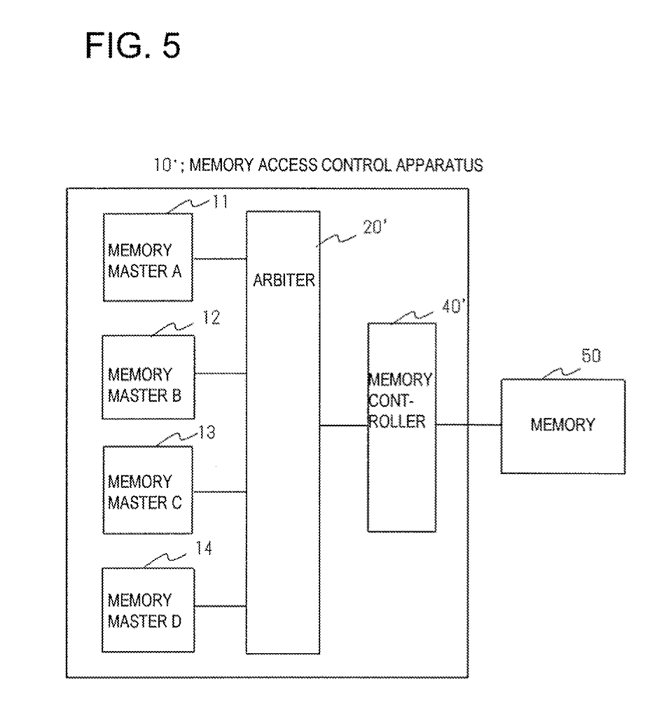

FIG. 6 is a diagram illustrating a memory access sequence in an system according to the related art.

### PREFERRED MODES

The present invention will be described in further detail with reference to the accompanying drawings. The present invention is so adapted that in a case where there is a memory access request from a prescribed memory master, the memory access latency of which is desired to be shortened, while a certain memory master is using the memory, the memory access by the memory master currently using the memory is suspended and the memory access by the prescribed memory master whose memory access latency is desired to be shortened is allowed to squeeze in. If interruption is performed unconditionally, memory access efficiency will undergo a marked decline. Interruption is allowed, therefore, only in a case where conditions are such that memory access efficiency will not be degraded.

In the present invention, besides an arbiter (20), a sub-arbiter (30) is provided for monitoring and arbitrating a memory access request by a prescribed memory master whose memory access latency is desired to be shortened.

The arbiter (20) includes an access dividing section (22) which divides memory access of a burst length more than one from a memory master into a plurality of short access units and sending a memory controller a memory access request for every short access unit.

If there is an access request from a prescribed memory master the memory access latency of which is desired to be shortened, the sub-arbiter (30) immediately issues the access request to memory controller (40). The sub-arbiter (30) monitors the memory access request from the arbiter (20). It is so arranged that the sub-arbiter (30) will not issue a memory access request in a case where memory access efficiency would be degraded if the sub-arbiter (30) were to issue the memory access request. It is so arranged that a memory access request from the sub-arbiter (30) is granted a priority higher than that of a memory access request from the arbiter (20). Since a memory access request from the arbiter (20) has been divided into short units, a memory access request from the sub-arbiter (30) is executed immediately (in a short waiting time). As a result, memory access latency by the prescribed memory master can be shortened. Specific exemplary embodiments will be described below.

### Exemplary Embodiments

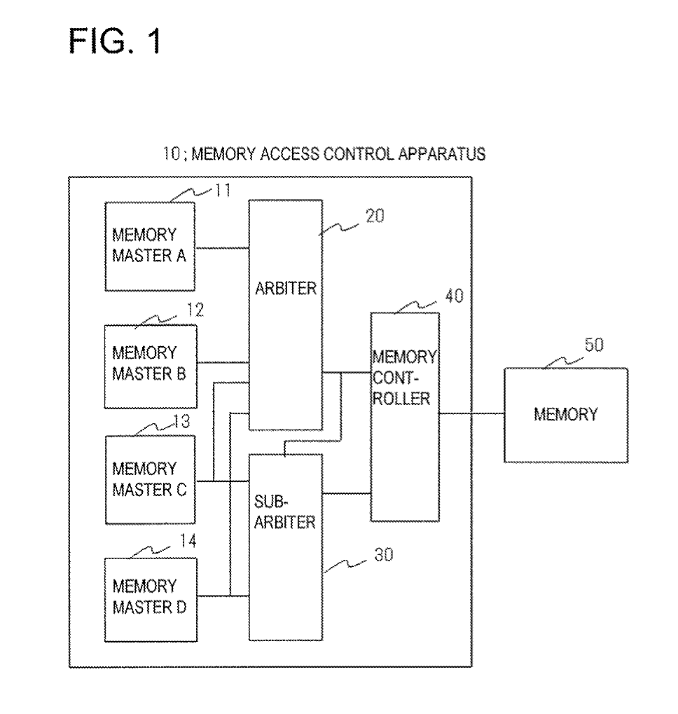

FIG. 1 is a diagram illustrating the configuration of a first exemplary embodiment of the present invention. The invention includes a memory access control apparatus 10 and a memory 50 having a plurality of banks. The memory access control apparatus 10 includes memory masters A (11) and B (12), memory masters C (13) and D (14), the memory access latency of which is desired to be shortened, an arbiter 20, a sub-arbiter 30 and a memory controller 40.

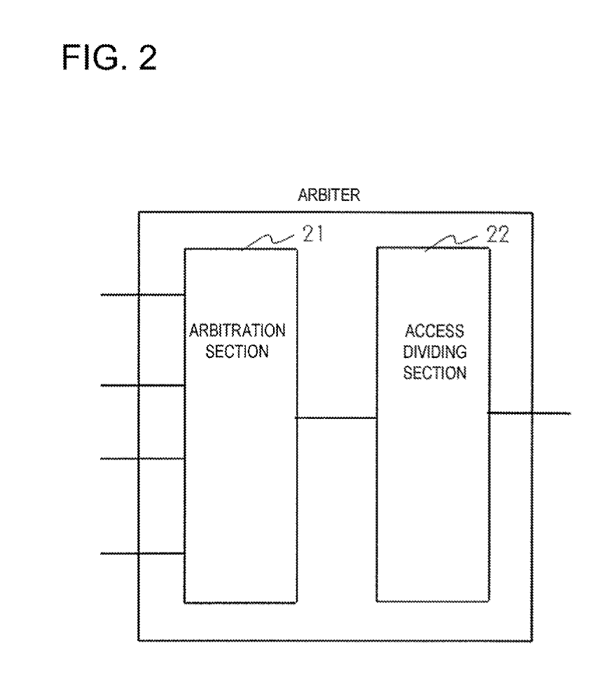

FIG. 2 is a diagram illustrating an example of the configuration of the arbiter 20 of FIG. 1. In this exemplary embodiment, with reference to FIG. 2, the arbiter 20 includes an arbitration section 21 which selects one memory master out of the plurality of memory masters 11 to 14, and an access dividing section 22 which, in a case where an access request from the memory master comprises has a burst length greater than two, divides this access request into accesses of a short burst length.

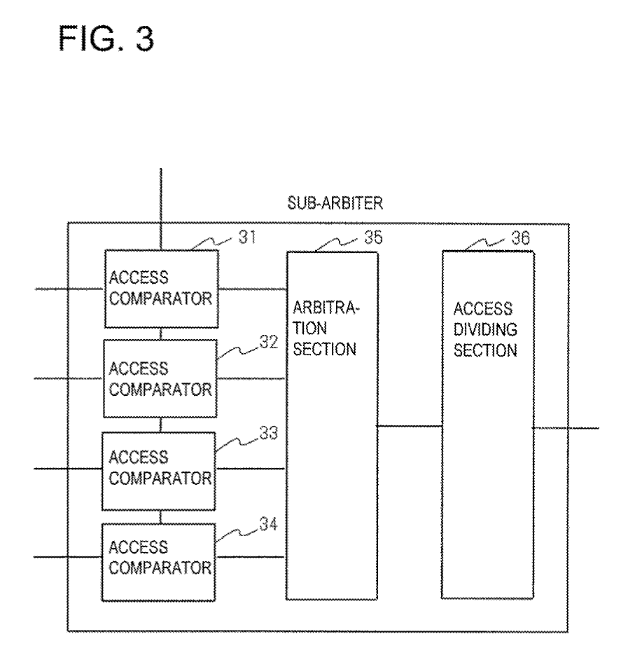

FIG. 3 is a diagram illustrating an example of the configuration of the sub-arbiter 30 of FIG. 1. In this exemplary embodiment, with reference to FIG. 3, the sub-arbiter 30 includes access comparators 31, 32, 33 and 34 which, for every memory master connected, compare access content of the memory master that the arbiter 20 is currently executing and access content that this memory master is requesting; an arbitration section 35 which selects one memory master out of the plurality thereof; and an access dividing section 36 which, in a case where an access request from the memory master has a burst length more than one, divides this access request into accesses of a short burst length.

The operation of this exemplary embodiment will be described below. The memory masters 11 to 14 issue respective memory access requests to the arbiter 20.

The arbiter 20 monitors the access requests from the plurality of memory masters 11 to 14. If memory access requests are issued from one or more memory masters and memory access is not in progress, then the arbiter 20 accepts an access request from a memory master. In a case where access requests have been issued from a plurality of the memory masters, the arbitration section 21 accepts an access request from one memory master, out of the plurality thereof issuing access requests, in accordance with a certain condition. By way of example, here the certain condition may be a fixed order of priority or a round-robin scheme.

In a case where an access request of a burst length more than one has been issued from a memory master whose request has been accepted, the arbiter 20 divides this access request into a plurality of short access units by the access dividing section 22. In the present invention, a short unit is an arbitrary length but preferably is the minimum access unit of the memory.

For example, in a case where the access dividing section 22 divides an access request into 2-burst length units, an 8-burst length access request from a memory master is divided into four 2-burst length access requests. In this case, the memory master issues a 2-burst burst access request to the memory controller 40 four times. Addresses of the individual access requests after access division are generated by the access dividing section 22.

The sub-arbiter 30 performs a series of control operations.

(a) The sub-arbiter 30 monitors requests from a plurality of memory masters whose memory access latency is desired to be shortened.

(b) Memory access requests are issued from one or more memory masters.

(c) The arbiter 20 is executing memory access.

(d) Using the access comparators 31 to 34 connected to the memory masters, the sub-arbiter 30 determines whether a condition is satisfied, the condition being that memory access efficiency will not decline even if memory access currently being executed by the arbiter 20 and memory access for which an access request is to be accepted by the sub-arbiter 30 are executed in succession.

(e) In a case where there are one or more memory masters for which the results of the determination by the access comparators 31 to 34 are true, the sub-arbiter 30 accepts an access request.

In a case where access requests have been issued from a plurality of memory masters and the results that are output from the access comparators connected to the plurality of memory masters are true, the arbitration section 35 accepts an access request from one memory master among these memory masters in accordance with a certain condition. By way of example, here the certain condition may be a fixed order of priority or a round-robin scheme.

When the sub-arbiter 30 accepts an access request, it issues the access request to the memory controller 40 immediately.

In a case where an access request having a burst length more than one has been issued from a memory master whose request has been accepted, the request is divided into a plurality of short access units by the access dividing section 36. However, the access dividing section 36 of the sub-arbiter 30 may just as well be eliminated. That is, an access request accepted by the sub-arbiter 30 need not be divided into short units.

The condition under which it is decided by the access comparators 31 to 34 that the memory access efficiency will not decline, is a case where:

(A) if a memory comprising a plurality of banks has been connected, the memory bank in use by an access request currently being executed by the arbiter 20 and a memory bank that the sub-arbiter 30 is to access are different; and

(B) the type of memory access, read or write, currently being executed by the arbiter 20 and the type of memory access, read or write, to be performed by the sub-arbiter 30 are identical.

By way of example, in a case where memory access currently being executed by the arbiter 20 is directed to bank 0 of the memory when a memory comprising four banks 0, 1, 2 and 3 has been connected, the sub-arbiter 30 will only accept memory access requests directed to banks 1, 2 and 3 and will not accept a memory access request directed to bank 0 of the memory.

Further, in a case where memory access being executed by the arbiter 20 is read, the sub-arbiter 30 will accept only a read access request and not a write memory access request.

If a memory comprising a single bank has been connected, a case where the type of memory access, read or write, currently being executed by the arbiter 20 and the type of memory access, read or write, to be performed by the sub-arbiter 30 are identical is the condition that there will be no decline in memory access efficiency.

The memory controller 40 accepts access requests from the arbiter 20 and sub-arbiter 30, generates the control signal of the memory 50 in accordance therewith and executes memory access.

In a case where memory access requests have been issued from both the arbiter 20 and the sub-arbiter 30, the memory controller 40 executes the memory access request of the sub-arbiter at a higher priority.

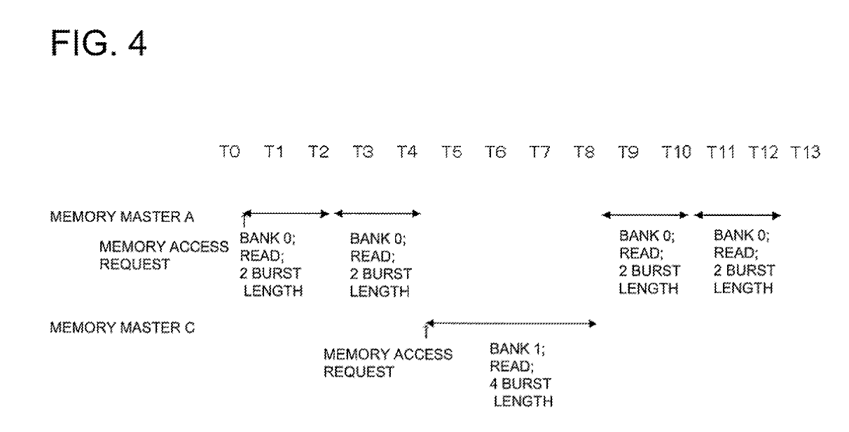

An specific example of operation of this exemplary embodiment will be described next with reference to FIG. 4. If memory master A issues an 8-burst length read memory access request to bank 0 of memory 50 at time T0, the arbiter 20 is not executing memory access at this time and therefore immediately accepts the memory access request from the memory master A, divides the request into two-burst memory access four times and, at time T1, outputs the initial two-burst access request to the memory controller 40.

At time T3, the initial 2-burst length read access ends and the arbiter 20 outputs the second 2-burst length read access request.

If memory master C issues a 4-burst length read memory access request to bank 1 of the memory at time T4, the sub-arbiter 30 compares this access with the access currently being executed by the arbiter 20. Since the access is to a different bank and the access requests are of the same type, the sub-arbiter 30 outputs a four-burst read access request to the memory controller 40 at time T5.

In this exemplary embodiment, a memory access request that has been accepted by the sub-arbiter 30 is not divided into short units.

Although a third access request is issued from the arbiter 20 at the same time, the memory controller grants priority to the memory access request from the sub-arbiter 30 and executes four-burst read access to bank 1.

At time T9, memory access from the sub-arbiter 30 ends and the third memory access request from the arbiter 20 is accepted and executed.

At time T11, the third read access ends and the final read access request is output. All access ends at time T13.

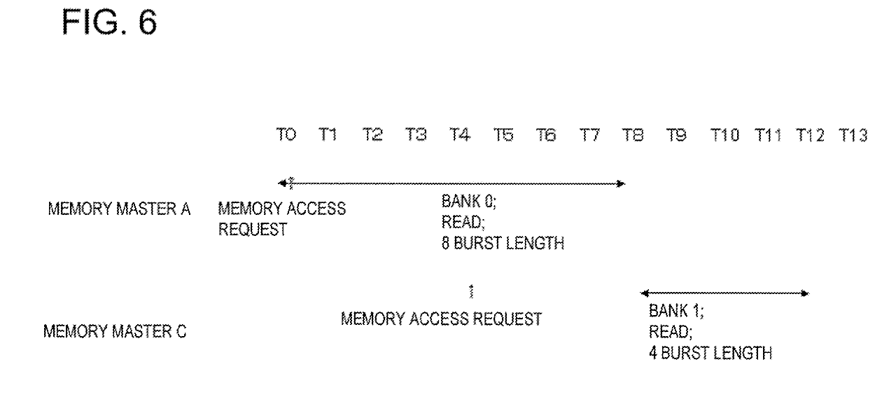

In accordance with this exemplary embodiment, memory access from the memory master C ends at time T9, as shown in FIG. 4, whereas it ends at time T13 in FIG. 6, which is referred to in the description of the related art.

It will be appreciated that memory access latency of the memory master C is reduced with the memory access apparatus of this exemplary embodiment.

In accordance with the present invention, memory access latency from a prescribed memory master can be shortened in a unified memory architecture or multiprocessor system, and it is possible to maintain a high memory access efficiency for the overall system.

The disclosures of Patent Documents 1 to 4 cited above are incorporated by reference in this specification. Within the bounds of the full disclosure of the present invention (inclusive of the scope of the claims), it is possible to modify and adjust the modes and exemplary embodiments of the invention based upon the fundamental technical idea of the invention. Multifarious combinations and selections of the various disclosed elements are possible within the bounds of the scope of the claims of the present invention. That is, it goes without saying that the invention covers various modifications and changes that would be obvious to those skilled in the art within the scope of the claims.

What is claimed is:

1-17. (canceled)

18. A memory access control apparatus comprising:
a plurality of memory masters, each of which issues an access request to a memory;
an arbiter that receives the access requests from the plurality of memory masters and arbitrating the access requests;
a sub-arbiter that receives access requests from at least a part of the memory masters out of the plurality of memory masters and that arbitrates the access requests; and
a memory controller that receives access requests from the arbiter and the sub-arbiter and that executes memory access to a memory connected thereto;
wherein in a case where a memory bank used by an access request allowed by the arbiter and currently being executed and a memory bank to be accessed by a memory master via the sub-arbiter are different, and
the type of an access request allowed by the arbiter and currently being executed and the type of access to be performed by a memory master via the sub-arbiter are identical,
the memory controller suspends memory access by the arbiter and allows the memory access by the sub-arbiter to squeeze in.

19. The memory access apparatus according to claim 18, wherein the sub-arbiter monitors a memory access request from the arbiter and exercises control in such a manner that in a case where memory access efficiency would be degraded if the sub-arbiter issues a memory access request, the sub-arbiter refrains from issuing the memory access request to the memory controller.

20. The memory access apparatus according to claim 18, wherein in a case where there are a plurality of the memory masters which satisfy a condition that there will be no decline in memory access efficiency, even if memory access for which the access request has been allowed by the arbiter and which is currently being executed and memory access which the sub-arbiter accepts are executed in succession, when the sub-arbiter accepts access requests from a plurality of the memory masters while the memory controller that has received an access request from the arbiter issued by the memory master is executing memory access,
the sub-arbiter selects the memory master for which the access request is to be executed from among the plurality of the memory masters that satisfy the condition in accordance with a predetermined criteria, and
the memory controller executes the access request selected by the sub-arbiter.

21. The memory access apparatus according to claim 18, wherein the sub-arbiter includes:
one or a plurality of access comparators, in association with respective ones of one or a plurality of memory masters connected thereto, each of the access comparators comparing access content of a memory master that the arbiter is currently executing and access content that the memory master is requesting; and
an arbitration section that selects one memory master out of the plurality of memory masters;
wherein the sub-arbiter monitors an access request from a memory master, from among the plurality of memory masters, the memory access latency of which is desired to be shortened; and
decides, by the access comparators connected to the memory masters, whether a condition is satisfied, the condition being that memory access requests have been issued from one or more memory masters, the arbiter is executing memory access, and there will be no decline in memory access efficiency, even if memory access being executed by the arbiter and memory access for which an access request is to be accepted by the sub-arbiter are executed in succession, and
accepts an access request in a case where there are one or more memory masters for which the results of the decision by the access comparators are true.

22. An access control apparatus comprising:
an arbiter that receives access requests from a plurality of master apparatuses and that arbitrates the access requests;
a sub-arbiter that receives access requests from at least a part of the master apparatuses out of the plurality of master apparatuses and that arbitrates the access requests; and
a controller that receives access requests from the arbiter and the sub-arbiter and that executes access to a device connected thereto;
wherein in a case where an access destination of the device used by an access request allowed by the arbiter and currently being executed and an access destination of the device to be accessed by a master apparatus via the sub-arbiter are different, and
the type of an access request allowed by the arbiter and currently being executed and the type of access to be performed by a master apparatus via the sub-arbiter are identical,
the controller suspends access by the arbiter and allows the access by the sub-arbiter to squeeze in.

23. The access control apparatus according to claim 22, wherein the sub-arbiter monitors a memory access request from the arbiter and exercises control in such a manner that in a case where access efficiency would be degraded if the sub-arbiter issues a memory access request, the sub-arbiter refrains from issuing the access request.
